(19) United States
(12) Patent Application Publication
(10) Pub. No.: US 2004/0148205 A1
(43) Pub. Date: Jul. 29, 2004

(54) Travel agency override calculation tool

(76) Inventor: Joseph James DeBell, Gainesville, VA (US)

Correspondence Address: Mr. Joseph J. DeBell, 13781 Charismatic Way, Gainesville, VA, 20155, US

(21) Appl. No.: 10/351,144

(22) Filed: Jan. 27, 2003

(51) Int. Cl. G06F 17/60

(52) U.S. Cl. 705/5; 705/1

(57) ABSTRACT

This invention is a useful process consisting of an algorithm tool for use on computers. It is a set of logic and arithmetic algorithms, operating on a familiar computer application interface, which assists users such as travel agencies in maximizing returns from their sales incentive arrangements with various airlines. No such aid currently exists in the travel industry. The field to which this invention pertains is that of a “set” or group of arithmetical algorithms that transform input data representing discrete dollar amounts or percentages, through a series of logic and mathematical calculations, into useful results: (1) displayed real time “status” positions of the using agency in terms of achieving incentive (discrete dollar) goals, or failing to reach those goals; (2) if failing to reach incentive goals, displaying the amount of additional effort in discrete dollar amounts and numbers of airline tickets necessary to reach minimum and subsequent and maximum incentive goals; and (3) displayed discrete dollar amounts of incentive moneys to be earned with various input data (dollar amounts) representing additional planned sales efforts (scenario “what if”). To the best of the inventor's knowledge this process does not exist today in prior art.

### BACKGROUND OF THE INVENTION

01 This invention is a tool for the travel agency enterprise (business). This invention is a self-calculating algorithm tool, which performs electronic and logic calculating functions, to assist travel agencies in managing their sales incentive arrangements with various airlines in such a way as to maximize their incentive dollar return from such arrangements. The field to which this invention pertains is that of a “set” or group of logic and arithmetic algorithms that transform travel agency input data, which is either discrete dollar amounts or percentage values, through a series of logic and mathematical calculations, into useful results: (1) displays to the user real time “status” positions of the using travel agency regarding the achievement of incentive (discrete dollar) goals, or the failure to reach those goals; (2) if failing to reach the incentive goals, displays to the user the amount of additional sales effort, both in discrete dollar amounts and numbers of airline tickets, necessary to reach minimum, subsequent, and maximum incentive goals; and (3) displays to the user discrete dollar amounts of incentive moneys to be earned with various user input data (dollar amounts) representing additional planned sales efforts of the travel agency (scenario “what if”). The subject matter here is a “set” of electrical formulas and logic algorithms providing a calculating function that has been uniquely designed to be utilized in the practice and management of an enterprise (travel agency).

02 Within the U.S. and international travel industry, many U.S. and international airlines offer specific cash incentives to travel agencies as a special motivation to increase volume/sales on that airline. Such cash incentive is called in the industry “cash overrides” or simply “overrides”. The scenario of agreement between the airline and the travel agency, or in some cases between the airline and a business consortium of travel agencies (as example, American Express Travel Agencies), often runs as such: The airline indicates that if the travel agency (or consortium) does nothing special in the way of promoting and selling that airline in a particular market (called a “peer” market), then the airline could, based on past sales experience, expect a certain percentage (called “peer percentage”) of all the tickets sold in a period by that travel agency to be on that airline. As example, in a defined “peer” market such as Chicago, Ill. (O'Hare Airport) or Dulles Airport, Virginia, where United Airlines has a major “hub”, travel agencies in those defined areas would normally, with no special sales effort on their part, be expected to sell about 32% of all their airlines tickets on United Airlines during the first calendar quarter, simply because those areas are United Airlines “hubs” and most of the flights going out of those airports will be on United Airlines. The “peer percentage” then, for United Airlines for travel agencies in those defined areas, would be 32%. The airline-defined “peer percentage” changes on a quarterly and seasonal basis, and also will be different (lower) at “non-hub” areas for that airline. The “peer percentages” are also of course different for each airline, depending on their general market share or hub airports.

03 The airline then indicates to the travel agency that if the travel agency sells above that “peer percentage”, known as “above peer”, then the airline will pay the travel agency cash “override” payments, the amount of which is dependent on how much above the “peer percentage” the travel agency sells in the evaluation period. For example: if a particular travel agency sells United Airlines 110% above “peer” during an evaluation period, usually a calendar quarter, United Airlines will pay 3% of the value of all tickets sold on that airline during that period. For a large travel agency, selling a large amount of United Airlines tickets, this can be a significant amount of money. The airlines, as part of the “override agreement”, provide “payout tables” and schedules, which define the monies that can be earned when the agencies reach certain levels of sales “above peer” on that airline, in accordance with airline rules.

04 In today's travel industry climate of very little or virtually zero airline commissions to travel agencies, almost all US and International airlines still retain these incentive (“override”) arrangements to reward high travel agency producers. Such cash incentive arrangements have now become very important to travel agencies 05 The problem: The airlines set all the “payment” rules for these incentive (override) arrangements, including what sales volume “counts” and what does not, and the “above peer” goals that must be reached. Also, It is only at the time of incentive payment, usually 45-60 days after the end of a particular calendar quarter, that the airlines tell the travel agencies what the travel agency's “peer percentage” goals were, what their performance was with regard to those “peer” goals, and how much, if any, override money they earned from the previous quarter's sales operations. So the travel agency owner with such an agreement works throughout the evaluation calendar quarter without knowing “where he stands” or how much more he may need to do in sales to make incentive (“Override”) money. It is difficult for the travel agency owner to incentivize his/her staff. It is not usual to have worked hard all quarter, only to discover 30 days later that they “just missed” making override money. What was needed was a set of easy to use predictive algorithms that provide the agency owner with this information.

06 This new utility process, solves, in three areas, the problems indicated above, that travel agency owners have: (1) of not knowing their status during the evaluation period; that is, where they) stand at any time during any particular quarter (evaluation period) regarding whether they will receive incentive money or not, and if they do how much; (2) knowing during any calendar quarter (evaluation period) how much their “shortfall” is and how much more they have to do in sales volume on a that airline to reach the incentive reward (dollar) level, and higher levels of reward; and (3) provides the capability to play “what if” scenarios regarding planned increased amounts of sales volume on a that airline to see the result in override monies they may receive. This new utility process presents it's solutions in an easy to understand, familiar format that does not require significant computer training on the part of the travel agency owner or employer. They simply have to view an already familiar application (such as Microsoft Excel) and understand how their own airline overrides program works. The process does all the rest, automatically and quickly.

### BRIEF SUMMARY OF THE INVENTION

01 This new process is the development of a set of self-calculating logic and arithmetic algorithms, operating on a familiar computer interface, whose object is to generate three (3) useful products (results) in the form of predictive percentage or dollar value outcomes for any travel agency that has a volume incentive arrangement with a specific airline (an “override” agreement). The use and solutions are arrayed in an easy to use and understand format/interface:

02 The first useful result: A product (dollar amount) is generated that represents the dollar amount, at any particular operational point in time (status point), of cash incentive (“override”) monies that may be expected to be paid to the travel agency at the end of a specified evaluation period (i.e.; a calendar quarter), given that the agency has exceeded the airline-designated productivity (sales) requirements (the “peer” percentage requirement) within the specified period. If the travel agency at this point has not exceeded airline-designated productivity (sales) requirements (the “peer” percentage requirement), it will then produce products indicating “% TOO LOW”, and “NO MONEY”. That is, it will show a “current status” (the travel agency will receive money, or, the travel agency will not receive money). (IF: THEN).

03 The second useful result: As soon as the initial product result is obtained, (as in paragraph 02 above), the process automatically generates as a product the dollar amount, and the number of specific airline tickets, of “shortfall” volume; that is, the volume of sales that would be needed to be sold on that airline during the evaluation period in order to receive the (1) the minimum level of override monies, and (2) higher levels of override monies at each of the designated airline “productivity payout levels”, up to the maximum payout level. Thus a travel agency can instantly see how much more sales volume, or number of tickets, on a that airline is needed in the remainder of the evaluation period in order to (1) qualify for payment, or, (2) reach the next or any level of payment, or, (3) reach the maximum level of payment. (IF: THEN).

04 The third useful result: The travel agency can initiate “What If” queries and receive an immediate product. By the action of the agency (user) entering a dollar amount representing planned additional sales on that airline during the evaluation period, the process instantly generates a product that represents a new forecasted override dollar amount that may be reasonably expected to be paid to the travel agency at the end of the evaluation period (i.e.; a calendar quarter); given of course that the agency has exceeded the airline-designated (“peer” percentage requirements) within that period. That is, it provides an iterative “what if” capability (IF; THEN).

05 The generation of each of the above-described useful products is a product of the result of the action of a “set” of self-calculating logic and arithmetic algorithms. It is this “set” of logic and arithmetic algorithms that has been derived and assembled by the inventor into a useful process and is the claim of this patent application. The “set” of logic and arithmetic algorithms is inserted into and operates on a familiar (to a large number of potential users) computer interface such as a Microsoft Excel application. The user simply has to enter a value into one of five (5) specially designated (yellow shaded) Excel cells (described below), and the extant, built-in logic and arithmetic algorithms instantly calculate the first two results described immediately above (status and any “shortfall” requirement). The user may then enter a dollar value into a sixth specially designated (yellow shaded) “What If” Excel cell (described below), and the extant, logic and arithmetic algorithms instantly calculate the third result described immediately above (Para. 04). To use the process, the user enters into:

a. The first of five (yellow) cells: The agency's total dollar value of all airline tickets sold on all airlines so far during the evaluation period (called “ARC” (US), or “BSP” (other countries)). Expressed as a dollar value.

b. The second of five (yellow) cells: The expected airline “peer requirement” for the evaluation period in question, expressed as a percentage. Obtained from travel agency historical airline reports.

c. The third of five (yellow) cells: The agency's total dollar value of all airline tickets flown so far on that specific airline (for example, United Airlines).

Expressed as a dollar value.

d. The forth of five (yellow) cells: A dollar value representing “adjustments” to the third cell (“flown”), based on the airline's rules regarding what flown value “counts” or does not in the evaluation. Expressed as a dollar value.

e. The fifth of five (yellow) cells: A dollar value representing the average airline ticket price of the airline tickets flown so far on that specific airline (e.g., United Airlines). Expressed as a dollar value.

f. The sixth (yellow) cell: A dollar value representing a “what if” query such as: “What if we sell $60,000 more on this airline this quarter?” Expressed as a dollar value (e.g.: $60,000).

These are the only cells the user needs to (or can;—all other cells are “locked”) enter data into. The extant formulas then instantly produce the results described above. Each “set” of logic and arithmetic algorithms uses the specific values and rules of a designated airline, initially selected by the travel agency owner (user). The “set” of logic and arithmetic algorithms is “assembled” (e.g.; by the inventor) and then inserted into a Microsoft Excel grid cell interface for the travel agency, using the values in each airline's particular “override agreement” with the travel agency and the airlines' “payout tables” and rules. The “set” of algorithms remains the same for any airline; the only changes that address a particular airline would be in numerical values within the algorithm formula structures.

### BRIEF DESCRIPTION OF THE DRAWINGS

01 The drawings appended to this submission depict examples of the Travel Agency Override Calculation Tool application screen as a travel Agency owner (user) would see it on his/her computer, with the built in “set” of logic and arithmetic algorithms (which cannot be seen by or tampered with by the user). The only cells that the user may affect are the six data entry cells (yellow shaded). All others are “locked” and the algorithms hidden from view. It uses the example of United Airlines to show the process at work. There are four (4) figures (black and white) provided, each showing the process results under four situations. On the user computer interface, the process is in color, with the six potential entry cells shaded in yellow.

FIG. 1. This figure demonstrates the situation wherein the travel agency's performance is not enough to earn override money; the process indicates that fact and also indicates the amount of sales “shortfall” in terms of dollars and number of United Airlines tickets.

FIG. 2. This figure demonstrates the situation wherein the travel agency's performance is good enough to earn some override money but at a low percentage and dollar payout; the process indicates that fact and also indicates the amount of sales “shortfall” in terms of dollars and number of United Airlines tickets, for several levels of reward, including maximum payout percentage.

FIG. 3. This figure demonstrates the situation wherein the travel agency's performance is good enough to earn some override money but at a low percentage and dollar payout (similar to FIG. 2); the process indicates that fact and also indicates the amount of sales “shortfall” in terms of dollars and number of United Airlines tickets, for several levels of reward, including maximum payout percentage. However here the user has, using the “What If” capability, entered a dollar amount into the sixth (What If) yellow cell and can see the result, in terms of increased override monies, of producing additional sales during the period.

FIG. 4. This figure demonstrates the situation wherein the travel agency's performance is very good; good enough to earn the maximum percentage. The process indicates that fact, displaying the amount earned and at what percentage, and also indicates that there is no shortfall. The user of course can, using the “What If” capability, still enter a dollar amount into the sixth (What If) yellow cell and can see the result, in terms of even increased override monies, of producing even more sales during the period.

### DETAILED DESCRIPTION OF THE INVENTION

01 This new process is represented by the development of a series of logic and arithmetic algorithms that perform a series of functions useful to the user of the process, usually a travel agency owner. The set of logic and arithmetic algorithms are what has been developed by the inventor to solve the problems defined in the Sections above; that is: (1) knowing where the user (e.g.; a travel agency) stands at any time during any particular quarter (airline evaluation period) regarding whether they will receive incentive (override) money or not, and if they do, how much money; (2) if they will not earn override money in the current circumstance, knowing how much their “shortfall” is during any calendar quarter (airline evaluation period) and how much more they would have to do in sales volume on that airline to reach the minimum incentive reward (dollar) level (their “shortfall), and any of several higher levels of reward; and (3) provides the capability to play “what if” scenarios regarding planned increased amounts of sales volume on that airline to see the result in override monies they may receive given they did perform at that level.

02 The “set” of logic and arithmetic algorithms that have been developed by this inventor are inserted into a blank array of Microsoft Excel cells, and upon insertion by the user of dollar or percentage entries into one of five (5) specially designated (yellow shaded) Excel cells (described above), the extant arithmetic formulas and algorithms instantly calculate whether the travel agency will receive any override money and how much, and if not receiving money, what the “shortfall” dollar volume and number of tickets amount is to reach the minimum payout level and any of several higher levels of reward. If the user wants to play “What If” scenarios, the user may then enter a dollar value into a sixth specially designated (yellow shaded) “What If” Excel cell (described above), and the extant arithmetic algorithms instantly calculate the override payout monies to be expected with each potential volume entered.

03 Definitions. The following definitions are used in this discussion:

a. ARC: Airlines Reporting Corporation. The US clearinghouse and financial reporting agency for all airline tickets issued by US travel agencies. The term “ARC” is used to mean the total of all tickets on all airlines ticketed (“booked”) by US travel agencies within a specific period. Includes Hawaii and Alaska.

b. BSP: Billing Service Provider. A general term used to define any International clearinghouse and financial reporting agency for airline tickets issued by international (non-US) travel agencies. The term “BSP” is used to mean the total of all tickets on all airlines ticketed (“booked”) by international (non-US) travel agencies within a specific period.

c. Domestic: Airline flights originating and ending totally within the confines of the US; includes Hawaii and Alaska.

d. Peer: That airline-defined group of travel agencies within the same geographic airline market area. Also called peer Group.

e. Flown: The dollar volume of tickets actually flown on a particular airline, as opposed to those just “ticketed” or “booked”. Tickets actually used for flight.

f. Adjustments: Airline-defined flown volume that may be added to or subtracted from flown revenue to reach what the airline determines as “what counts” or does not count for flown override payments. As example, an airline may add in international flown to a domestic program, or subtract taxes, group or convention tickets, government volume, etc. from the flown amount.

g. Qualifying Revenue: The resulting flown revenue dollar amount that the airline recognizes as qualifying as “airline flown”. Equals flown plus or minus adjustments. Given that the travel agency has performed “above peer”, this is the dollar amount the airline will apply to the “payout table” to determine the amount of override money to be paid to the travel agency.

h. Payout Table: A table of percentages (of Qualifying Revenue) vs. agency levels of performance that the airline will pay to the travel agency. As example, for 101% above peer, pay 1% of Qualifying revenue; for 104% above peer, pay 2% of Qualifying revenue; for 107% above peer, pay 3% of Qualifying revenue, etc.

04 The generation of logic and arithmetic algorithms for all of the needed functions described in the Sections above are described in the next three paragraphs. These are the “set” of logic and arithmetic algorithms that I have developed.

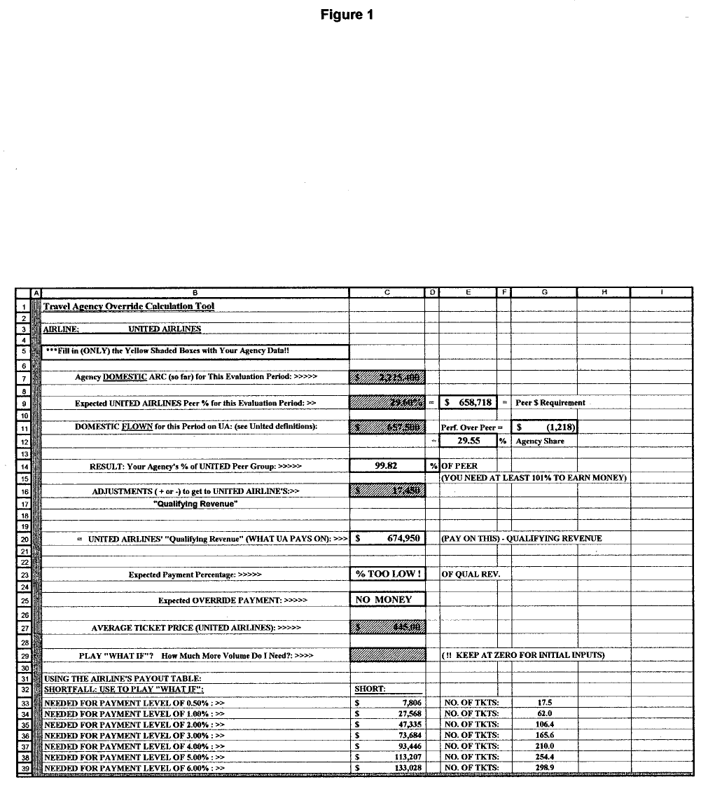

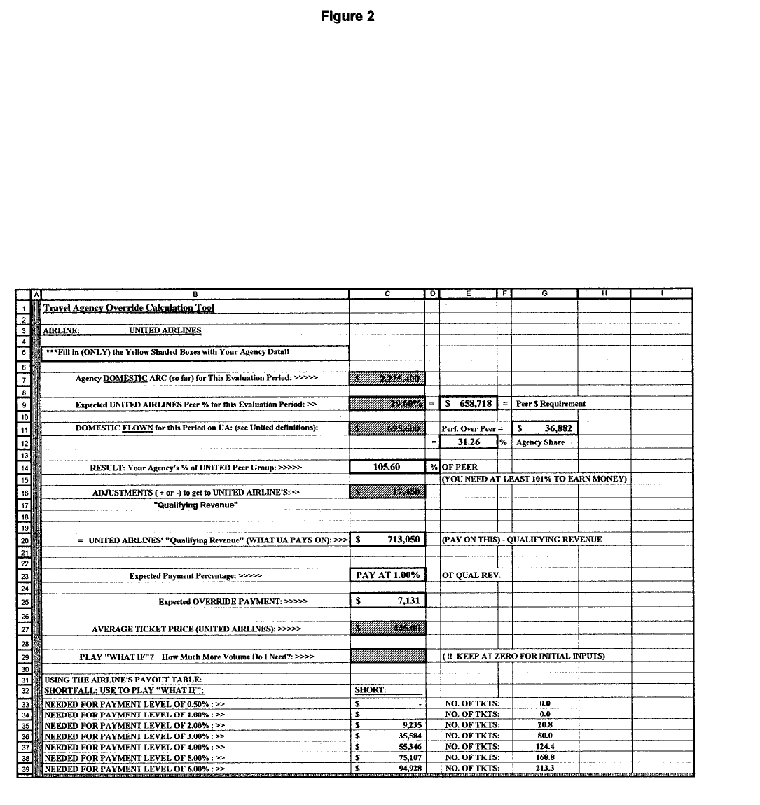

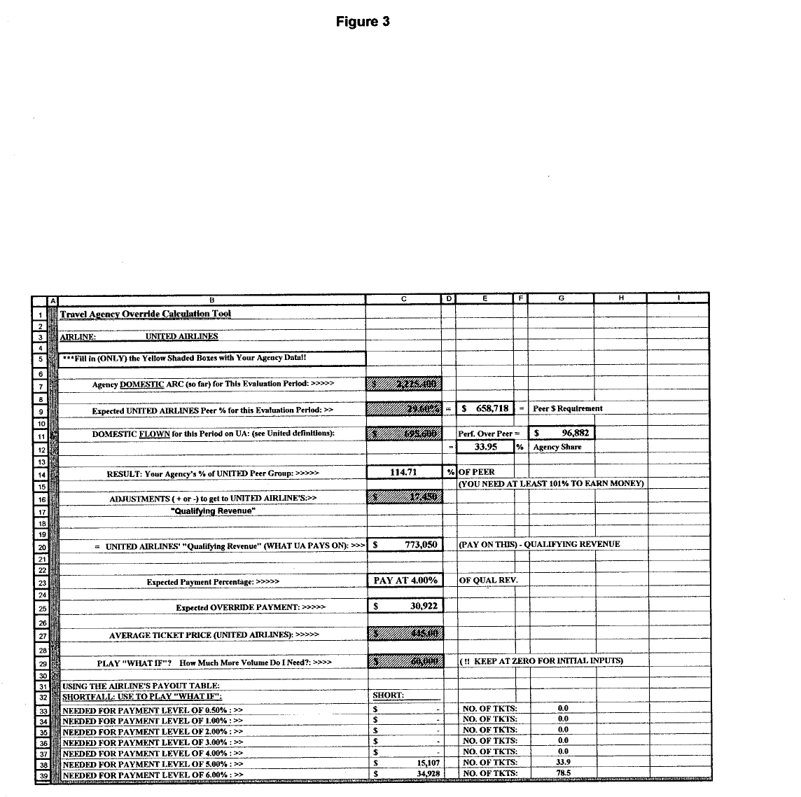

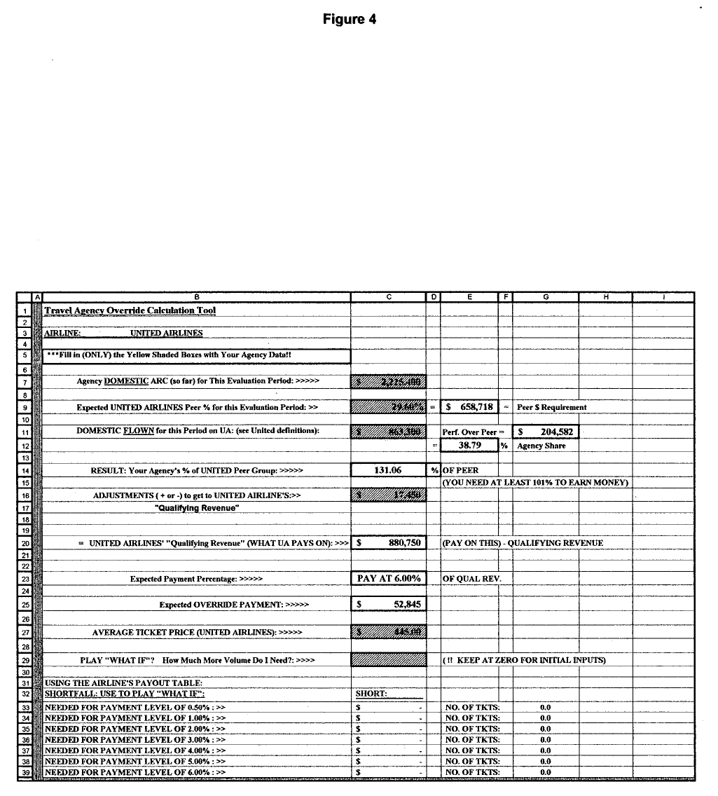

a. Consider a gridded Microsoft Excel spreadsheet of cells (please see FIG. 1) of dimensions A1 (using Microsoft Excel conventions—upper left of spreadsheet) to H40 (using Microsoft Excel conventions—lower right of spreadsheet), wherein the Alpha represents the column designation and the Numeric represents the row designation. The cell locations expressed below in the formulas and algorithms are in the same Microsoft Excel convention; for example, an alphanumeric designation of C29 refers to the cell at the intersection of column C and row 29. Normal arithmetic conventions are applied in formulas and algorithms. Drawing FIGS. 1 through 4 will be used as the prime examples and illustrations of the process.

b. In order to produce the three products described in paragraph 01 above, the process will use the data entered by the user into designated (yellow shaded) cells as value elements for the logic and arithmetic algorithms already there. These actions will initially produce four (4) interim products reflecting the agency's percentage and dollar level of performance against the airline's “peer” percentage requirements. The process uses this data to immediately produce the desired products indicating five “states” or “situations”:

(1) That based on the calculated percentage of the agency's performance against “peer”, the agency will earn override money, and display the percentage of Davout it earned (e.g.; 1%, 2%, 3%, 4%, 5%, 6%, etc.)

(2) That based on the calculated percentage of the agency's performance against “peer”, the agency will earn override money, and display the amount of money, in dollars, that will be earned.

(3) That based on the calculated percentage of the agency's performance against “peer”, the agency will not earn override money, and display the messages: “% TOO LOW!” and “NO MONEY”.

(4) That based on the calculated percentage of the agency's performance against “peer”, and that the agency's performance was not high enough to earn override money, display the “shortfall” amount needed, both in dollars and in numbers of airline tickets, to earn the minimum amount of money, and any of several higher levels of reward.

(5) Given that the user wanted to play “What If” scenarios, display the effect of potential additional sales on the override money to be earned, expressed in dollars.

05 To illustrate the process and its operation, consider that the user must first “enter” data into five specific cells (identified yellow shaded) as follows (using the “grid” cell identifiers earlier described). Please refer to the “definitions” earlier provided: All of the arithmetic formulas and algorithms are “hidden”, that is, not visible to the user (a Microsoft Excel feature). All cells in the grid, with the exception of the “enterable” (yellow shaded) cells, are “locked” and unchangeable by the user (a Microsoft Excel feature). For illustrative purposes, we assume here that we are evaluating the travel agency's performance regarding Domestic airline ticket sales on United Airlines. Depending on the airline's override agreement with the travel agency, International ticket sales may be substituted for Domestic. Reference to Drawing FIG. 1 through FIG. 4. Wherever it indicates “User enters.” means into a yellow shaded cell.

a. User enters into cell C7: the agency's Domestic ARC ticketed so far for this evaluation period (in dollars, e.g.; $2,225,400).

b. User enters into cell C9: the expected airline peer percent for this evaluation period (as a percentage, e.g.; 29.6%).

c. Cell E9 contains the formula: =(C7*C9) and calculates and displays the dollar amount of the airline peer requirement (e.g.; $658,718).

d. User enters into cell C11: the domestic revenue flown in the particular airline during this evaluation period (e.g.; $657,500).

e. Cell G11 contains the formula: =(C11+C29)−C9 and calculates and displays the dollar amount (plus or minus) of the agency's performance over peer (e.g.;−$1,218, a minus figure indicating below peer). Note: Cell C29 is the sixth yellow-shaded “What If” cell that a user may enter a dollar value to play “what if” scenarios. It is normally left empty (blank) during initial process operation, but if a value is entered in it, that value will be added to the C11 cell (flown revenue) for all subsequent calculations.

f. Cell E12 contains the formula: =(C11+C29)/C7*100 and calculates and displays the agency's performance over or under peer as a percentage of peer (e.g.; 29.55%). Note that this value is below the expected airline peer percent of 29.60% entered in step b. above.

g. Cell C14 contains the formula: =((C11+C29)/E9)*100 and calculates and displays the agency's percent of the airline's peer group (e.g.; 99.82%). For this airline, according to it's “payout table”, the minimum percent of the airline's peer group the agency must achieve, to receive any override money, is 101%; so it is already apparent in this example that this travel agency is below peer and will not receive override money for this evaluation period.

h. Cell C23 is labeled “Expected Payment Percentage”, and contains a set of “nested” logic formulas that describe what is to be displayed in the cell given certain values of the cell C14 (Agency's % of United's Peer Group), such that if the agency's percent of the airline's peer group is below 101% (as it is in this initial example) the cell C23 will display “% TOO LOW!”. If above 101%, the cell C23 will display “PAY AT X %” where X is the value derived by the payout formulas. The logic formulas are:

=IF(C14<101,(I33),IF(C14>=101,(I34),IF(C14>=104,(I35),IF(C14>=107,(I36),IF(C14>=110,(I37),IF(C14>=114,(I38),IFC14>=117,(I39),IF(C14>=120,(I40)))))))).

Note: The cell designations (I33) through (I40) in the formulas refer to cells within the grid that contain the text to be displayed in cell C23 given cell C14 is of that range of values (101%-120%):

(I33)=“% TOO LOW!”

(I34)=“PAY AT 0.50%”

(I35)=“PAY AT 1.00%”

(I36)=“PAY AT 2.00%”

(I37)=“PAY AT 3.00%”

(I38)=“PAY AT 4.00%”

(I39)=“PAY AT 5.00%”

(I40)=“PAY AT 6.00%”

i. Cell C25 is labeled “Expected Override Payment” and contains a set of “nested” logic algorithms that describe what is to be displayed in the cell given certain values of the cell C14, such that if the agency's percent of the airline's peer group is below 101% (as it is this initial example) the cell C25 will display “NO MONEY”. If above 101%, the cell C25 will display the dollar amount that the agency may expect as an override payment from the airline. The logic formulas operative in cell C25 are:

=IF(C14<101,(I32),IF(C14>=101,(C20*0.005),IF(C14>=

104,(C20*0.010), IF(C14>=107,(C20*0.020),IF(C14>=110,(C20*0.030),IF(C14>=114, (C20*0.040),IFC14>=117,(C20*0.050),IF(C14>=120,(C20*0.060)))))))).

Note: The cell designation (I32) in the formula refers to a cell that contains the text “NO MONEY” to be displayed in the cell C25 if the agency's percent of the airline's peer group is below 101% (as it is in this initial example). Otherwise, what will be displayed in cell C25 will be the product of cell C20 (“Qualifying Revenue”) times a percentage (depending on the value of C14), in this case varying from 0.5% to 6.0%. The value of Cell C20 (“Qualifying Revenue”) is addressed immediately below.

j. Cell C20 is labeled “Airline Qualifying Revenue” (What the airline pays on). The formula in this cell is: =C 1+C29+C16. Cell C29 is the “What If” cell and has been previously addressed and described (above) and is initially left blank by the user. Per the airline rules, “Qualifying Revenue” is the result of “Flown Revenue” (cell C11) modified by “adjustments”. Cell C16 is the fourth user data input cell (yellow shaded), and the user input here (cell C16) is the “adjustments” (in dollars), plus or minus, that must be made to the airline “flown” dollar value based on the airline's rules of “what counts”, as explained above earlier (for instance, subtract taxes, commissions, government tickets, and group discounted tickets, and add in Atlantic international flown tickets). Thus the value derived by the formula in C20 is the “adjusted” (via cell C16) dollar amount that the airline will use to calculate what will be paid by the airline as the override incentive money, and is called “Airline Qualifying Revenue”. Thus the user may enter into cell C16 the dollar value $17,450, and cell C20 would immediately reflect C11 ($657,500) plus C29 ($0) plus C16 ($17,450)=$674,950. This is the dollar amount that the airline will apply percentage payouts to given that the travel agency has exceeded peer percentage requirements (in this case, 101% of peer) to arrive at an override payment amount.

k. Cell C27 is the fifth user data input cell (yellow shaded). The user input here is the airline's average ticket price during the evaluation period so far; for example, $445.00.

l. The example being described illustrates that the current status of the travel agency is that it will not receive any override money; that their performance falls short of the required percentage of the airlines peer group (the minimum required percentage of peer s 101%, as seen in step f. above). It would now be useful to the travel agency to know what their “shortfall” amounts are, in terms of dollar (ticket value) volume, and number of tickets (based on average ticket price). The next group of logic and arithmetic algorithms perform that function and will deliver a series of product results indicating the travel agency's “shortfall” or additional amounts, in terms of both dollar amounts and corresponding number of tickets on that airline (given that the user has performed step k. above and entered the airline's average ticket price in cell C27), needed to reach the minimum productivity level to receive any override money, (which amounts would then be displayed via the formulas described above; see step i above), or any of a series of increasing levels of override money payout levels, to include the maximum payout level.

m. The “shortfall” determination process here uses the interaction of logic and arithmetic formulas located at different cell locations in the Excel cell grid to produce the display indicating the shortfall in terms of dollars and number of tickets. It must be remembered that the travel agency must exceed the airline peer by 101% (in this example) in order to get to the minimum level of override payout. To find the shortfall, the concept is:

(1). If the peer times 1.01 minus “flown” revenue is a value less than zero, it means that “flown” is higher than 101% of peer; that the travel agency has exceeded peer by at least 101% and has reached at least the minimum performance level to earn override money. The cell displaying the “shortfall” should display zero in dollars. That amount, divided by the average ticket price from cell C27 (step k. above) yields the number of tickets; in this case, zero.

(2). If the peer times 1.01 minus “flown” revenue is a value greater than zero, it means that “flown” is below 101% of peer; that the travel agency has not exceeded peer by at least 101% and has not reached at least the minimum performance level to earn override money. The “shortfall” would then be equal to peer times 1.01 minus “flown”, and the cell displaying the “shortfall” should display that amount, in dollars. That amount, divided by the average ticket price from cell C27 (step k. above) yields the number of tickets; in this case, a number.

(3). Formulas for (1) and (b) above are repeated for the various levels of payout per the airline's payout table; the only changes being the percent performance needed to get to that higher level; e.g.; 104%, 107%, 110%, 114%, 117% and 120%.

(4). A mathematical example (See FIG. 1, and 2):

(a.) Travel agency did not reach 101% of peer.

Airline ticket price: $440.00.

Peer=$658,718

Total Flown=$657,500

Peer times 1.01=$665,305=101% of peer

101% of peer—Total Flown=“Shortfall”

$665,306−$657,500=$7,806=“Shortfall” in dollars ($7,806).

$7,806 divided by $445.00=“Shortfall” in tickets (17.5).

(b.) Travel agency did reach at least 101% of peer.

Airline ticket price: $445.00.

Peer=$658,718

Total Flown=$695,600

Peer times 1.01=$665,305=101% of peer

101% of peer−Total Flown=“Shortfall”

$665,305−$695,600=($30,295) “Shortfall”

A negative shortfall number returns $0 Shortfall 0 divided by $440.00=0 tickets needed.

n. The following addresses and describes the logic and mathematical algorithms that yield the “Shortfall” results and displays, depending upon the extant performance level of the travel agency.

(1) Cell H33 is the first of seven vertically arrayed cells that contain the mathematical formulas that describe the relationship between the percentages needed over peer and the total amount entered as “flown”. From above, Cell E9 is peer requirement in dollars; cell C11 and C29 together equal total flown in dollars.

The formula in cell H33: =(E9*1.01)−(C11+C29)

The formula in cell H34: =(E9*1.04)−(C11+C29)

The formula in cell H35: =(E9*1.07)−(C11+C29)

The formula in cell H36: =(E9*1.10)−(C11+C29)

The formula in cell H37: =(E9*1.14)−(C11+C29)

The formula in cell H39: =(E9*1.17)−(C11+C29)

The formula in cell H40: =(E9*1.20)−(C11+C29)

(2) Cell C33 is the first of seven vertically arrayed cells that contain the logic (if: then) and mathematical algorithms that will decide, based on the value results of the cells H33, H34, H35, H36, H37, H38, and H39 (see concept described above), the value to be displayed, either zero or an amount in dollars representing the “Shortfall”. From above, Cell E9 is peer; cell C11 and C29 together equal total flown.

The formula in cell C33: =IF(H33<=0,0,(E9*1.010001)−(C11+C29)

The formula in cell C34: =IF(H34<=0,0,(E9*1.040001)−(C11+C29)

The formula in cell C35: =IF(H35<=0,0,(E9*1.070001)−(C11+C29)

The formula in cell C36: =IF(H36<=0,0,(E9*1.100001)−(C11+C29)

The formula in cell C37: =IF(H37<=0,0,(E9*1.140001)−(C11+C29)

The formula in cell C38: =IF(H38<=0,0,(E9*1.170001)−(C11+C29)

The formula in cell C39: =IF(H39<=0,0,(E9*1.200001)−(C11+C29)

The results of the calculations, in each cell, will be displayed in dollars and will represent the “Shortfall” amount required to reach the initial or next level of payment.

(3) Cell G33 is the first of seven vertically arrayed cells that contain the mathematical formulas that will derive the number of airline tickets represented by the “Shortfall” and the number of airline tickets needed to reach the next level of payment. Cells C33 through C39 represent the “Shortfall” in dollars; cell C27 is the value of the average airline ticket on this airline.

The formula in cell G33: =C33/C27

The formula in cell G34: =C34/C27

The formula in cell G35: =C35/C27

The formula in cell G36: =C36/C27

The formula in cell G37: =C37/C27

The formula in cell G38: =C37/C27

The formula in cell G39: =C39/C27

The results of the calculations, in each cell, will be displayed as a number and will represent the “Shortfall” in tickets required to reach the initial or next level of payment.

06 The last of the three desired useful products described in paragraph 01 of this Section (above) provides the capability to play “what if” scenarios regarding planned increased amounts of sales volume on that airline to see the result in override monies the travel agency may receive given they did perform at that level. This simply involves inserting a dollar amount into cell C29. Such amount is added to that in cell C11 (“Flown”) in all of the calculating formulas described in paragraphs 04 and 05 above. Upon initial use of this process, the user always leaves the value in cell C29 empty (he is directed to do so) so that only the value in cell C11 (“Flown”) is effective and the user may see where he/she stands. However, note that in all instances of use of cell C11 value in formulas and algorithms, cell C29 value is also present; you always see the combination (C11+C29) in all formulas. The effect is to simply add in the “what if” value when there is a value in C29. The result of such action is an apparent larger amount “flown”, and the process treats it as such.

07 The “set” or collection of logic and arithmetic formulas and algorithms, the total of those specifically delineated in paragraphs 5.c., 5.e., 5.f., 5.g., 5.h., 5.i., 5.j., and 5.n. of this Section, represent the operable agents in this process, and provide all of the useful products described in the introduction (paragraphs 01 and 02) to this section.

1. I claim as my invention the conceiving of and bringing together into a working “set”, the below detailed group of interrelating and interacting logic and arithmetic algorithms (formulas), as has in example form been specifically described and delineated in paragraphs 5.c., 5.e., 5.f., 5.g., 5.h., 5.i., 5.j., and 5.n. of the DETAILED DESCRIPTION OF THE INVENTION above. The conceiving of and bringing together this “set” of instructions operating together defines the process that is the invention called Travel Agency Override Calculation Tool.
An important note: In the example detailed in paragraphs 5.c., 5.e., 5.f., 5.g., 5.h., 5.i., 5.j., and 5.n. of the DETAILED DESCRIPTION OF THE INVENTION above, the cell designations (for example, C14) used simply depict a Microsoft Excel grid cell location at or within which the operation defined by the instruction is being executed. The location of the operative interrelating and interacting logic and arithmetic instructions (formulas); that is, exactly which cell they are in on the Microsoft Excel grid, is not significant. The important item is the relationship of the operands one to the other and the operative logic and/or arithmetic function described in each instruction. Stated below is that “set” of instructions that operate together to accomplish the objectives of the process. I have removed the essentially arbitrary Microsoft Excel cell designations. The lettering of subparagraphs a.-j. below are in reference to paragraphs 05.c., 05.e., 05.f., 05.g., 05.h., 05.i., 05.j., and 05.n. of the DETAILED DESCRIPTION OF THE INVENTION above, and are each indicated in parentheses immediately after the alpha paragraph designator. These designations indicate where that part of the “set” or group of logic and arithmetic algorisms operates within the whole process that makes up the invention Travel Agency Override Calculation Tool. Percentages and multiplier numbers are representative of the example used in the DETAILED DESCRIPTION OF THE INVENTION above and may be different depending on the airline override contract used. The term “what if” indicates the entry inserted into the “What If” cell described in paragraph 05 of the DETAILED DESCRIPTION OF THE INVENTION above. The set (group) of logic instructions (algorithms) and formulas are:
a. (05.c)=(Agency ARC times Expected Airline Peer Percent)
b. (05.e)=(Flown plus “what if” flown)-Expected Airline Peer Dollars
c. (05.f=(Flown plus “what if” flown)/Agency ARC times100
d. (05.g)=((Flown plus “what if” flown)/Expected Airline Peer Dollars) times 100
e. (05.h)=IF(Agency's Percent of Peer Group<101,(“% TOO LOW”),IF(Agency's Percent of Peer Group>=101,(“PAY AT 0.50%”),IF(Agency's Percent of Peer Group>=104,(“PAY AT 1.00%”),IF(Agency's Percent of Peer Group>=107,(“PAY AT 2.00%”),IF(Agency's Percent of Peer Group>=110,(“PAY AT 3.00%”),IF(Agency's Percent of Peer Group>=114,(“PAY AT 4.00%”),IF(Agency's Percent of Peer Group>=117,(“PAY AT 5.00%”),IF(Agency's Percent of Peer Group>=120,(“PAY AT 6.00%”)))))))). Percent numbers are variable depending on airline contract.
=“% TOO LOW!”
=“PAY AT 0.50%”
=“PAY AT 1.00%”
=“PAY AT 2.00%”
=“PAY AT 3.00%”
=“PAY AT 4.00%”
=“PAY AT 5.00%”
=“PAY AT 6.00%”
f. (05.i)=IF(Agency's Percent of Peer Group<101,(“NO MONEY”),IF(Agency's Percent of Peer Group>=101,(Qualifying Revenue*0.005),IF(Agency's Percent of Peer Group>=104,(Qualifying Revenue*0.010),IF(Agency's Percent of Peer Group>=107,(Qualifying Revenue*0.020),IF(Agency's Percent of Peer Group>=110,(Qualifying Revenue* 0.030),IF(Agency's Percent of Peer Group>=114,(Qualifying Revenue*0.040),IF Agency's Percent of Peer Group>=117,(Qualifying Revenue*0.050),
IF(Agency's Percent of Peer Group>=120,(Qualifying Revenue*0.060)))))))). (Entire string is nested formula)
g. (05.j)=Flown+what if+Adjustments
h. (05.n)=(Expected Airline Peer Dollars times 1.01)−(Flown+what if)
=(Expected Airline Peer Dollars times 1.04)−(Flown+what if)
=(Expected Airline Peer Dollars times 1.07)−(Flown+what if)
=(Expected Airline Peer Dollars times 1.10)−(Flown+what if)
=(Expected Airline Peer Dollars times 1.14)−(Flown+what if)
=(Expected Airline Peer Dollars times 1.17)−(Flown+what if)
=(Expected Airline Peer Dollars times 1.20)−(Flown+what if)
i. (05. n)=IF(Expected Airline Peer Dollars times 1.01)−(Flown+what if)<=0,0,(=(Expected Airline Peer Dollars times1.010001)−(Flown+what if)
=IF(Expected Airline Peer Dollars times 1.04)−(Flown+what if)<=0,0,(=(Expected Airline Peer Dollars times1.040001)−(Flown+what if)
=IF(Expected Airline Peer Dollars times 1.07)−(Flown+what if)<=0,0,(=(Expected Airline Peer Dollars times 1.070001)−(Flown+what if)
=IF(Expected Airline Peer Dollars times 1.10)−(Flown+what if)<=0,0,(=(Expected Airline Peer Dollars times 1.100001)−(Flown+what if)
=IF(Expected Airline Peer Dollars times 1.14)−(Flown+what if)<=0,0,(=(Expected Airline Peer Dollars times 1.014001)−(Flown+what if)
=IF(Expected Airline Peer Dollars times 1.17)−(Flown+what if)<=0,0,(=(Expected Airline Peer Dollars times 1.170001)−(Flown+what if))
=IF(Expected Airline Peer Dollars times 1.20)−(Flown+what if)<=0,0,(=(Expected Airline Peer Dollars times 1.200001)−(Flown+what if
j. (05.n)=Amount needed for initial payment level/airline average ticket price.
=Amount needed for next payment level/airline average ticket price.
=Amount needed for next payment level/airline average ticket price.
=Amount needed for next payment level/airline average ticket price.
=Amount needed for next payment level/airline average ticket price.
=Amount needed for next payment level/airline average ticket price.
=Amount needed for final maximum payment level/airline average ticket price.
